(19) United States
(12) Patent Application Publication
(10) Pub. No.: US 2003/0183109 A1
(43) Pub. Date: Oct. 2, 2003

(54) Integrated detonating or firing element, and use thereof

(76) Inventors: Joachim Rudhard, Leinfelden-Echterdingen (DE); Hans Artmann, Magstadt (DE); Thorsten Pannek, Stuttgart (DE); Franz Laermer, Weil Der Stadt (DE); Klaus Heyers, Reutlingen (DE); Sabine Nagel, Asperg (DE)

Correspondence Address: KENYON & KENYON, ONE BROADWAY, NEW YORK, NY, 10004, US

(21) Appl. No.: 10/321,134

(22) Filed: Dec. 17, 2002

(30) Foreign Application Priority Data
Dec. 19, 2001 (DE) 101 62 413.1

(51) Int. Cl. F03H 1/00; B64G 1/26; F42C 1/00

(52) U.S. Cl. 102/200; 244/169

(57) ABSTRACT

An integrated detonation element or firing element including a base member, e.g., a silicon member, and a reaction region associated therewith, is provided. The reaction region includes porous silicon and an oxidizing agent for silicon. An arrangement is provided with which a chemical reaction is initiated between the oxidizing agent and the porous silicon. The detonation or firing element is suitable principally for use in a microreactor; in a microbooster, e.g., for course correction of satellites; as a firing element in a gas generator for a belt tensioner or an airbag, e.g., in motor vehicles; or as a primer for the ignition of explosive charges.

### FIELD OF THE INVENTION

The present invention relates to an integrated detonating element or firing element as well as the use thereof.

### BACKGROUND INFORMATION

Thin-film technology is often utilized in conventional integrated firing elements, such as are used to fire explosive charges, e.g., in airbag gas generators or belt tensioners. In this technology, thin-film metal conductor traces and/or oxide layers of metals or rare earths positioned above or next to one another, which have been applied onto a wafer using a sputtering technique and patterned thereon, chemically react exothermically with one another when current flows so that the thermal energy for firing of the actual propellant charge is thereby made available. The quantity of material that reacts in this case is limited, however, to the relatively thin metal traces or oxide traces, resulting in low firing energies.

It is an object of the present invention to make available an integrated, reliable detonating or firing element that is easy to fire electronically.

### SUMMARY OF THE INVENTION

The integrated detonating or firing element according to the present invention may be fired economically, electronically, and very easily, as well as being integrated directly into, for example, the gas generator propellant charge of an airbag module. The firing element according to the present invention may also very easily be connected to a usual electronic bus system by which the command to fire the detonating or firing element is accomplished, especially in the case of an airbag or a belt tensioner, thereby at the same time achieving excellent reliability due to the elimination of connecting wires, for example, to a conventional “firing pellet.”

The integrated firing element according to the present invention may provide that when principally used for airbag firing, that it readily makes possible graduated firing of multiple gas generator propellant charges that include respectively associated firing elements in the context of a “smart” airbag concept.

The integrated detonating or firing element not only makes available sufficient thermal energy to initiate a chemical reaction in the reaction region between the porous silicon and the oxidation medium, but also a powerful explosion, with evolution of heat and pressure, already occurs in the integrated firing or detonating element. This results in very reliable firing of a propellant charge that, in many applications, is positioned after the firing element. Since the quantity of material converted in this explosion is substantially greater, due to incorporation of the material of the surrounding base member that may be made of silicon, than is the case with conventional approaches, the explosion also simultaneously releases substantially greater quantities of energy as compared to conventional systems.

The firing or detonating element according to the present invention may provide that due to its high detonation speed, even high explosives based on nitrogen compounds, or plastic explosives, may be directly caused to detonate by priming via a combined temperature and shock wave. The firing element is thus also suitable for the construction of primers for non-automotive applications, for example in a microreactor, a microbooster that is often used for course correction of satellites, or as an igniter for explosive charges.

### BRIEF DESCRIPTION OF THE DRAWING

FIG. 1 shows a cross-section through an integrated firing element according to the present invention produced by surface micromechanics.

### DETAILED DESCRIPTION

The example embodiment explained below makes use of a specific property of porous silicon, which in conventional fashion may be produced, in an IC-compatible process, in a surface region of a silicon wafer by electrochemical anodization in a hydrogen fluoride-containing electrolyte. Another effect utilized is that, as is known, it is possible—simultaneously with, previously to, or after the production of porous silicon—also to integrate an electrical signal processing system or an electronic driver section into the silicon wafer.

Microporous or nanoporous silicon has a very large internal surface area which makes it highly chemically reactive. The oxidation of silicon also releases a comparatively large amount of molar energy that greatly exceeds the heat of oxidation of carbon.

In addition to the reactivity of a large silicon surface area per se, hydrogen that derives from the anodization reaction in the production of porous silicon and is often bonded to the surface of the porous silicon, and/or silane-like compounds from it bonded thereon, result in a further increase in the reactivity of the porous silicon and the release of energy upon its oxidation.

It is thus found, for example, that freshly produced porous silicon reacts in a powerful explosion upon contact with highly concentrated nitric acid. If weaker or inhibited oxidizing agents are used, on the other hand, an explosive reaction occurs only if thermal activation has first occurred.

If porous silicon is filled with an oxidizing agent that has been “inhibited” in this sense, for example using a liquid phase or a sol-gel process, what results is, for example, a film-like reaction region made up of ultra-finely distributed oxidizing agent and nanostructured or microstructured porous silicon, which reacts explosively upon thermal activation. In the simplest case, the oxidizing agent used may even be pure oxygen bonded in the porous silicon, which is introduced into the resulting porous silicon in liquid or gaseous form after processing of the silicon wafer is complete.

In the example embodiment explained here, one or more usual conductor traces, for example meander-shaped resistance conductor traces, that extend over, under, or next to the reaction region including the porous silicon, may be used for thermal activation of this reaction.

When these conductor traces have an electric current applied to them, firstly a temperature rise occurs in the vicinity of the porous silicon filled with the oxidizing agent, i.e., in at least a portion of the reaction region; and initiation of the explosively proceeding oxidation reaction of the silicon also occurs.

The conductor traces may be produced in the same IC process that is also used for an integrated signal processing system. They may be made of aluminum, AlSi, or AlSiCu, depending on the metal used for the corresponding IC process. Other metals or electrically conductive compounds are also suitable in principle, however, for implementing the conductor traces.

Production of the porous silicon by electrochemical porosification may moreover be accomplished before the actual IC process, i.e., at the “front end,” the initially produced porous silicon then being protected from thermal collapse, for the duration of the subsequent IC process, by surface oxidation. After completion of the IC process including wiring of the conductor traces that have been produced, e.g., in order to manufacture a firing conductor, the stabilizing oxide is then removed again from the internal surface of the porous silicon by brief immersion in dilute hydrofluoric acid, and immediately thereafter the oxidizing agent is introduced into the porous structure, dried, and the microstructured component thus manufactured by surface micromechanics is sealed.

A polyimide or another polymer, which may be applied in the form of a film over the reaction region that forms a surface region of the silicon wafer that is used, is suitable for sealing.

In an alternative processing procedure, the electrochemical porosification of the silicon may also be performed at the so-called “back end” of the IC process, i.e., only after completion of IC processing and after the conductor trace wiring that optionally follows it; this may provide that the porous silicon produced in this step is immediately filled with oxidizing agent and the oxidizing agent may then be dried. This may then be once again followed by sealing, for example using a polyimide film, of the reaction region constituted by porous silicon and the introduced oxidizing agent.

Mixed forms of front-end and back-end processing are additionally possible, i.e., porosification of the silicon before application of the firing conductor traces after the rest of the IC process is complete, for example, is also possible.

A plurality of inorganic or organic compounds that release oxygen, fluorine, chlorine, or other oxidizing substances when heated, as well as oxygen itself, are suitable as the oxidizing agent for production of the integrated detonating or firing element according to the present invention. An oxidizing agent that releases oxygen may be used.

Examples of suitable oxidizing agents are inorganic nitrates such as potassium nitrate, sodium nitrate, ammonium nitrate; inorganic peroxides such as barium peroxide or manganese peroxide; organic peroxides such as benzoyl peroxide; chromates, dichromates, permanganate, hypochlorites, chlorite, chlorates, or perchlorates, for example potassium perchlorate or sodium perchlorate, each of which is first dissolved in suitable solvents such as water and applied locally, for example using usual dispensing techniques, onto the region including the porous silicon.

Application of the dissolved oxidizing agent may be accomplished by spraying a well-defined quantity of liquid from a dispenser onto the porous silicon so that a reaction region made up of porous silicon and oxidizing agent forms, the porous silicon, constituting a sponge-like structure, being at least partially penetrated by the oxidizing agent and impregnated therewith. The use of a dispenser facilitates the establishment of a quantity of oxidizing agent that is optimum for filling the volume of porous silicon. Alternatively, oxygen or a nitrogen oxide such as N₂O, NO, or NO₂, which becomes bonded in the porous silicon structure, may also be used.

Once the oxidizing agent introduced into the reaction region including the porous silicon has been dried, the resulting moisture-sensitive structure is sealed, i.e., is at least largely closed off in hermetically sealed fashion with respect to the entry of water and/or atmospheric moisture. For that purpose, for example, a polymer is applied or spun-coated onto the reaction region using a dispenser, so that a sealing polymer film is created.

In connection with the aforementioned moisture sensitivity of the reaction region including porous silicon and oxidizing agent, it should additionally be emphasized that the oxidizing agents most suitable are those that are as water-repelling and non-hygroscopic as possible, which is the case, e.g., for potassium perchlorate. It is further worth noting that many polymers, such as polyimides, do not seal completely but instead tend to absorb water over time, so that an oxidizing agent which is as water-repellent as possible is advantageous in order to maintain reactivity in the reaction region that has been produced, even in a moist environment, for a longer period.

In addition to the introduction of a liquid oxidizing agent into the reaction region including porous silicon, and subsequent sealing of the reaction region, it is lastly also possible for the oxidizing agent to be already combined with a sealing material. For example, an excess of benzoyl peroxide dissolved in styrene, or potassium perchlorate very finely distributed in polyimide or in melted paraffin, is suitable for this.

In the first case, upon drying, a portion of the benzoyl peroxide will radically polymerize the initially very low-viscosity styrene to form polystyrene, yielding a relatively well-sealing, compact plastic that still has a very strong oxidizing effect thanks to its excess of benzoyl peroxide.

In the second case, the polyimide will harden by drying or the paraffin by cooling, and will thus seal the reaction region including the porous silicon, and the oxidizing agent, as a hardened wax. Care should of course be taken that the temperature of the melted paraffin is kept below a critical value at which oxidation of porous silicon by potassium perchlorate begins.

Also possible, lastly, is a combination of the aforesaid examples, i.e., using, for example, a solution of benzoyl peroxide in styrene to which very finely divided potassium perchlorate or potassium dichlorate has simultaneously been added.

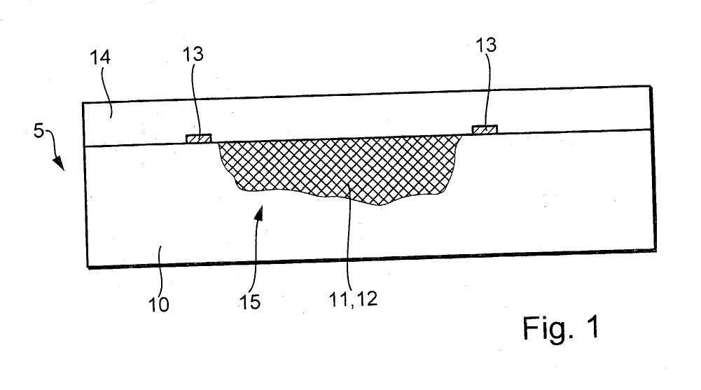

FIG. 1 illustrates the example embodiments described above using the example of a silicon wafer 10, serving as base member, in whose surface porous silicon 11 was first produced, by electrochemical porosification, in a defined reaction region 15.

One of the oxidizing agents 12 explained above was then introduced into reaction region 15 so that an intimate mixture of porous silicon and oxidizing agent, similar to a completely soaked and subsequently dried sponge, forms therein.

Lastly, usual conductor traces 13, which are made, e.g., of aluminum, AlSi, or AlSiCu, were produced locally on the surface of silicon wafer 10 in the vicinity of reaction region 15. These ensure that, when they are acted upon by a suitable electric current, thermal energy is transferred into reaction region 15, igniting therein an explosive exothermic chemical reaction between porous silicon 11 and oxidizing agent 12.

Lastly, a polyimide film 14, which closes off reaction region 15 in at least largely sealed fashion with respect to the entry of water or atmospheric moisture, is located on silicon wafer 10.

What is claimed is:

1. An integrated detonation element, comprising:
a base member including silicon, and having a reaction region that includes a porous silicon and an oxidizing agent for silicon; and
an arrangement that initiates a chemical reaction between the oxidizing agent and the porous silicon.

2. The integrated detonation element of claim 1, wherein the reaction region is arranged one of within the base member and on a surface of the base member.

3. The integrated detonation element of claim 1, wherein the reaction region includes a surface region of the base member.

4. The integrated detonation element of claim 1, wherein the integrated detonation element is a microstructured component produced by surface micromechanics.

5. The integrated detonation element of claim 1, wherein the arrangement generates thermal energy that acts on the reaction region and ignites an exothermic and explosive chemical reaction between the porous silicon and the oxidizing agent.

6. The integrated detonation element of claim 1, wherein the arrangement includes at least one conductor trace made of one of aluminum, AlSi, and AlSiCu, and wherein an electric current acts on the at least one conductor trace.

7. The integrated detonation element of claim 6, wherein:
the at least one conductor trace is arranged at least one of on the reaction region, under the reaction region, and in a vicinity of the reaction region.

8. The integrated detonation element of claim 1, wherein:
the reaction region is one of:
a sponge-like structure made of the porous silicon that is one of partially penetrated by the oxidizing agent, impregnated with the oxidizing agent, and superficially covered with the oxidizing agent; and
a mixture of the porous silicon and the oxidizing agent.

9. The integrated detonation element of claim 1, wherein the reaction region is closed off in at least a largely hermetically sealed manner with respect to one of water entry and atmospheric moisture.

10. The integrated detonation element of claim 1, wherein the reaction region is sealed with one of a polymer and a polymer film that is a polyimide.

11. The integrated detonation element of claim 1, wherein the oxidizing agent includes a compound that, upon heating, releases one of oxygen, fluorine, chlorine, and a substance that oxidizes silicon.

12. The integrated detonation element of claim 1, wherein the oxidizing agent includes at least one of an inorganic nitrate, an inorganic peroxide, an organic peroxide, a chromate, a dichromate, a permanganate, a hypochlorite, a chlorite, a chlorate, and a perchlorate.

13. The integrated detonation element of claim 1, wherein the oxidizing agent includes at least one of an oxygen gas and a nitrogen oxide gas.

14. The integrated detonation element of claim 1, wherein the reaction region includes one of a mixture, a dispersion, and a solution of the oxidizing agent with a material that closes off the reaction region in at least largely hermetically sealed manner with respect to one of water entry and atmospheric moisture.

15. The integrated detonation element of claim 16, wherein the reaction region is one of a solution of benzoyl peroxide in styrene, a mixture of potassium perchlorate in one of a polyimide and a paraffin, and a mixture of benzoyl peroxide, styrene, and potassium perchlorate.

16. The integrated detonation element of claim 1, wherein the oxidizing agent is at least one of water-repellent and non-hygroscopic.

17. The integrated detonation element of claim 1, wherein the integrated detonation element is one of used in a microreactor, used in a microbooster for course correction of satellites, used as a firing element in a gas generator for one of a belt tensioner and an airbag in motor vehicles, and used as a primer for the ignition of explosive charges.
